(19) United States
(12) Patent Application Publication
(10) Pub. No.: US 2022/0369578 A1
(43) Pub. Date: Nov. 24, 2022

(54) IRRIGATION CONTROLLER

(71) Applicant: NETAFIM, LTD., Tel Aviv (IL)

(72) Inventor: ROMAN LEV, MAOR (IL)

(73) Assignee: NETAFIM, LTD., TEL AVIV (IL)

(21) Appl. No.: 17/748,120

(22) Filed: May 19, 2022

Related U.S. Application Data
(60) Provisional application No. 63/190,488, filed on May 19, 2021.

(51) Int. Cl. A01G 25/16; H02J 4/00

(52) U.S. Cl. CPC A01G 25/16; H02J 4/00; H02M 1/0003

(57) ABSTRACT

An irrigation controller includes an electrical circuit suitable for receiving incoming power of either AC or DC voltage and operating valves of either AC or DC type. The electrical circuit has a power supply module, a driver and a microcontroller. The power supply module is arranged to convert the incoming power to DC voltage that is supplied into the electrical circuit. The driver includes outgoing ports that are connected to an irrigation valve coupled to the irrigation controller, and the microcontroller is arranged to control activation of the valve via the driver.

### RELATED APPLICATIONS

Priority is claimed to U.S. Provisional Patent Application No. 63/190,488, filed May 19, 2021. The contents of the aforementioned application are incorporated by reference in their entirety.

### TECHNICAL FIELD

Embodiments of the invention relate to an irrigation controller, and in particular to an irrigation controller that can operate valves of different types and/or with lower power consumption. More particularly, the irrigation controller is configured to control irrigation valves of the sort commonly found in or near a field being irrigated.

### BACKGROUND

Irrigation controllers are typically exposed to various types of electrical voltage that depend on the site where they are deployed. To address such variance in power supply, irrigation controllers may be designed to function with the type of electrical voltage that is available and to operate valves that are suited to the type of electrical current that the controller receives.

In addition, irrigation controllers should preferably work in unstable voltage conditions with relative low power consumption since electrical power may not always be abundant at the site where they are deployed, which at times may be a remote location in a field. Therefore, being able to provide to a valve the precise power that is requires for its operation is advantageous.

Valves being used by irrigation controllers may be of various types, each having a unique profile of electrical power consumption (“power profile”) according to the various stages of its operation.

Electromechanical solenoids for example of include an electromagnetically inductive coil wound around a movable steel or iron slug termed the armature. The coil is shaped such that the armature can be moved in and out of the coil's center, altering the coil's inductance and thereby becoming an electro-magnet. The armature is used to provide a mechanical force to some mechanism which operates the valve.

A solenoid's main electrical characteristic is that of an inductor, in that it possesses inductance, which is the characteristic that opposes any change in current. This is why current does not immediately reach a maximum level when a solenoid is energized. Instead, the current rises at a steady rate until it is limited by the resistance of the solenoid.

### SUMMARY

The following embodiments and aspects thereof are described and illustrated in conjunction with systems, tools and methods which are meant to be exemplary and illustrative, not limiting in scope.

In an aspect of the present invention there is provided an irrigation controller comprising an electrical circuit suitable for receiving incoming power of either AC or DC voltage and operating valves of either AC or DC type, wherein the electrical circuit comprises a power supply module, a driver, a microcontroller and sensing circuitry configured to detect current and/or voltages associated with valve operation. The power supply module is arranged to convert the incoming power to DC voltage that is supplied into the electrical circuit, the driver comprises a plurality of outgoing ports that are connected to one or more valves coupled to the irrigation controller, and the microcontroller is arranged to control activation of the valve via the driver.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows an electronic circuit of an irrigation controller according to an embodiment of the present invention; and

FIG. 2 schematically shows physical phenomena associated with a valve controlled via electrical input supplied by an embodiment of a controller of the present invention.

FIG. 2A shows details of pulse width modulation (PWM) waveform portions of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

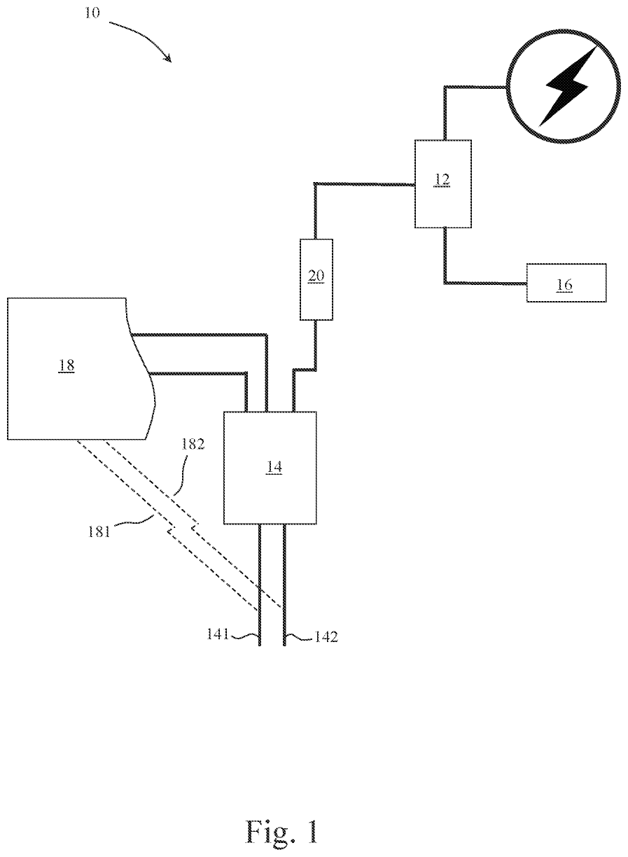

Attention is first drawn to FIG. 1 schematically illustrating an electric circuit 10 of an irrigation controller according to an embodiment of the present invention. Electric circuit 10 includes a power supply module 12 that is arranged to receive electrical power from a power source available at the location where the irrigation controller is deployed. In some embodiments, the power source is from AC mains. In other embodiments, the power source may be the DC output from one or more solar panels located in close proximity to the field served by the irrigation controller. In still other embodiments, the power source may be the output of or more wind turbines located in close proximity to the field served by the irrigation controller.

From power supply module 12, energy flows towards a driver 14 of the electric circuit and towards a possible battery 16 of the electric circuit where electrical power can be stored. Electrical circuit 10 in this example includes in addition a microcontroller 18 and a possible booster 20 located in between power supply module 12 and driver 14.

The circuitry illustrated in this view is schematic not showing all circuits and/or components that may exist in various embodiments. For example, the microcontroller may be configured to receive incoming power from power supply module 12 possibly via a Low-dropout regulator (LDO).

Incoming electrical power either of an AC or DC type, is transformed at power supply module 12 to DC voltage that feeds the electrical components of the irrigation controller's electric circuit. In a non-binding example, an incoming power supply of either AC or DC voltage at 220V may be transformed at the power supply module 12 to a power of 12V DC. The optional booster 20 may be used to boost up the voltage supplied within the electrical circuit e.g., to 24V DC (or the like) if needed.

Driver 14 may be provided with output ports for powering and controlling electrical valves associated to the irrigation controller. In the illustrated example seen in FIG. 1, two such output ports indicated 141 and 142 are shown, however additional ports may be provided for communicating with additional possible valves.

Microcontroller 18 may be arranged to control operation of driver 14 and may be arranged, inter alia, to sense electrical current provided via the ports of the driver towards a valve. Sensing channels 181, 182 here optionally linking driver ports 141, 142 to microcontroller 18 are representative of sensing circuitry that may be employed for such sensing of electrical current. It is understood that sensing circuitry for sensing such electrical current may be achieved at other locations within the electric circuit, such as at incoming ports of the driver (or the like).

In some embodiments, the microcontroller 18 may be a component from the TEXAS INSTRUMENTS® (TI) family of microcontrollers, such as the MSP430F1612 (https://www.ti.com/product/MSP430F1612, retrieved May 17, 2022), the driver 14 may be a TI DRV8823 (https://www.ti.com/product/DRV8823, retrieved May 17, 2022), and the LDO may be the TI TPS777 (https://www.ti.com/product/TPS777, retrieved May 17, 2022) and the booster 20 may be a DC-to-DC step-up regulator such as those also supplied by TI. People skilled in the art and given the corresponding data sheets for these components would understand how to implement a suitable electric circuit utilizing such electrical components. Furthermore, the sensing channels 181, 182 may comprise discrete components and/or circuits connected to the driver 14 and/or the microcontroller 18. In one embodiment, the discrete components and/or circuits are connected to the driver 14 and the microcontroller 18 obtains the corresponding measurements from the driver 14.

Electrical power provided to valves may be controlled by the microcontroller and driver to be either of a DC or AC type—and thus the irrigation controller of the present invention may be suited to connect to valves of both these types.

Thus, in an aspect of the present invention the electrical circuit of the irrigation controller may be suited for use with both AC and DC power supplies, and may be equally suited for use with valves of both AC or DC type.

In the example provided, such suitability for use with incoming power from both AC and DC power supplies may be obtained via use of power supply module 12 that receives the incoming power supply into the electric circuit, and the suitability for use with valves of both AC or DC type may accordingly be facilitated via microcontroller 18 and driver 14.

A driver 14 of the sort specified above can be configured to utilize a single port 141, 142 to drive a DC valve (or more particularly, the valve's solenoid). The same driver 14 may instead be configured to operate as a pulse width modulator using two of the ports 141, 142 in tandem and at a frequency corresponding to the input frequency (e.g. 50 Hz) of an AC valve which is driven thereby.

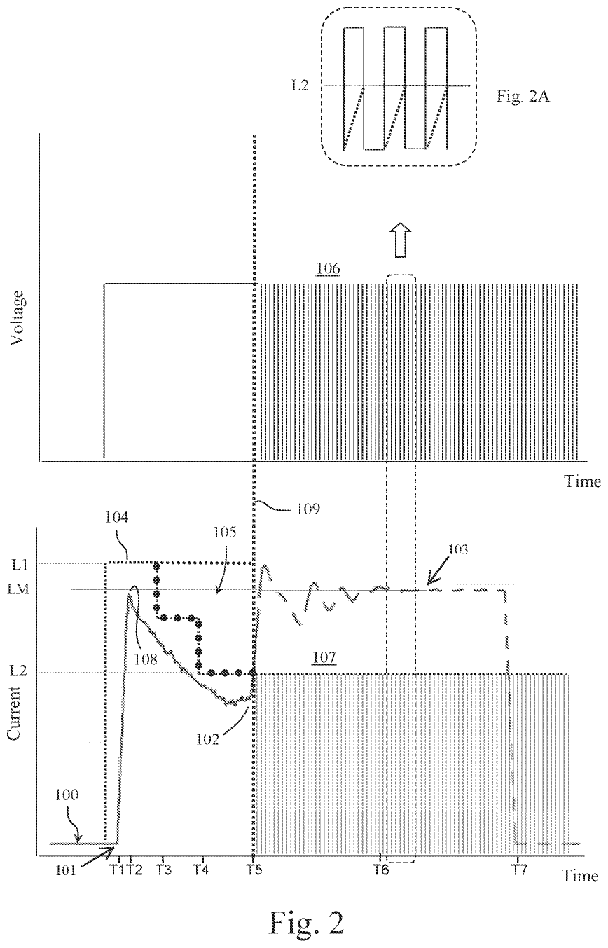

Attention is drawn to FIG. 2 to exemplify a possible method for powering and controlling an electrical valve by an embodiment of an irrigation controller that may include an electric circuit such as that illustrated in FIG. 1.

In a first possible step, the method may include receiving a load profile 100 of an electrical valve that is to be used and controlled by the irrigation controller. It is understood that the load profiles for various valve types may be pre-loaded into the microcontroller 18. This load profile 100 that is depicted in the lower graph of FIG. 2 shows the typical expected electrical current that the valve requires during various stages of operation over a time span that resembles e.g., transition between initial and terminal states, such as between ‘open’ and ‘closed’ states.

Load profile 100 in this example can be seen having several exemplary points of interest and stages that can be monitored in order to assist in the controlling of the valve.

A first point 101 at time T1 may be where the valve is actuated to start moving between states, such as between its ‘closed’ and ‘open’ states. From time T1 to time T5 along the load profile, the valve is said to be in the actuation stage.

A second point 102 along the load profile may be indicative of the beginning of the valve's wind-down stage where the valve completes transition between states. During the wind-down stage, seen as lasting from time T5 to T6 along the load profile, the current draw at the valve may initially peak and then oscillate before settling down to a constant maintenance current level LM.

After time T6 along the load profile, the valve enters a final stage, (indicated by reference numeral 103). In the final stage 103, the valve may already be at a terminal state (e.g., ‘closed’ state) without further movement.

In this example, load profile 100 is initially drawn as a ‘continuous’ line and generally after the vertical ‘dotted’ line immediately after point 102 (at time T5), is drawn as a ‘broken’ line. The ‘continuous’ line portion of load profile 100 is representative of both the expected and current sensed and monitored electrical current consumption of the valve—and the ‘broken’ line portion of load profile 100 is representative of the remaining expected electrical current consumption of the valve if it were to be exposed to un-controlled supply of electrical voltage. Thus, when exposed to an un-controlled power supply, the valve's tendency is to draw current even after the valve has closed at second point 102. And the current draw after the valve is closed (i.e. after time T5 along the load profile 100) represents wasted energy.

A control method according to an embodiment of the present invention may be to continuously sense via sensing channels such as 181, 182, the electrical current consumed by the valve. In an embodiment, the sensed electrical current consumed by the valve may be compared to the load profile of the valve in order to monitor and possibly control the electrical power provided to the valve.

In one aspect of the present invention, such monitoring may assist in detecting suspected malfunction of the valve. For example, if at a certain point in time e.g., after detection of start of activation of the valve—the sensed electrical current deviates above a certain, possibly pre-defined, threshold from the expected current according to the valve's load profile—an alert may be provided of possible malfunction in the operation of the valve. Information such as excess current draw may be fed back to the microcontroller which then may take corrective action via the driver 14. For example, if the sensing circuits indicate that a particular valve is drawing excessive current, the microcontroller may be configured to send appropriates signals to the driver 154, instructing the latter to reduce (or even altogether remove) power being supplied via the ports connected to that particular valve.

In another aspect of the present invention, such monitoring via the sensing circuits 181, 182 may also assist in lowering energy consumption by the valve, especially when that energy is not required for proper activation of that valve. This may be exemplified by the following schematics provided in FIG. 2.

In an embodiment, upon receiving a command e.g., to open a valve, the irrigation controller may expose the valve as seen in the upper graph provided in FIG. 2 to voltage that is suitable for activation of the valve, for example to 24 volts. This, as seen in the lower graph of FIG. 2, may result in an upper boundary 104 (“upper limit”) of inrush electrical current that can be consumed by the valve. More particularly, the microcontroller 18 directs the driver 14 to limit the inrush electrical current available to the valve during the aforementioned actuation stage between times T1 and T5.

As seen in the lower graph of FIG. 2, boundary 104 in this example may be set at a first current level L1 that is above the highest expected inrush electrical current 108 (reached at time T2) that the valve is expected to consume according to the load profile on route to second point 102 where the valve completes transition between the open and closed states.

The upper boundary 104 need not be set at a constant level for the entire actuation stage between times T1 and T5. In certain cases, microcontroller 18 as seen in the time interval 105 between times T3 and T5 (indicated with the larger dots) may vary the upper boundary of inrush electrical current that the valve may be allowed to consume. In the example shown, the upper boundary may be lowered in a step-like manner, with a first current lowering step occurring at time T3 and a second current lowering step occurring at time T4.

In certain embodiments, the microcontroller by monitoring the consumed inrush electrical current by the valve, can detect if the consumed electrical current exceeds the set upper boundary for current that in this example is represented by the ‘dotted line’, a situation that may indicate malfunction of the valve.

In addition or alternatively, the microcontroller 18 may be set to detect that the actual inrush current consumed by the valve follows an expected pattern of electrical current consumption, for example in this case a pattern where the inrush electrical current initially rises (to point 108 at time T2) and then decreases (towards point 102) and then rises again. If the microcontroller 18 does not detect such a pattern, it may send a signal and/or activate an alarm indicating a possible malfunction of the valve.

In certain cases, upon detection of a possible malfunction in the valve, the microcontroller may be arranged to momentarily cause the driver 14 to activate pulse width modulation (PWM) to try and urge the valve to function as expected.

In cases where the microcontroller 18 determines that the valve is operating properly, a transition in the sensed inrush current after second point 102 may be indicative of the valve properly reaching an activated terminal state. Such transition after second point 102 may be detected in this example by a subsequent rise in consumed electrical current by the valve. The vertical ‘dotted’ line 109 extending between the lower and upper graphs in FIG. 2 accordingly indicates the point in time T5 along the load profile where a transition after second point 102 has been confirmed.

Once the rise in current beyond second point 102 has been detected, the microcontroller may activate pulse width modulation (PWM), as shown in the illustrated PWM stages 106 and 107 (after time T5) that indicate, respectively, the voltage pulses and resulting current pattern. During the PWM stage, the microcontroller 18 may direct the driver 14 to provide a holding current level L2 that is sufficient to maintain and hold the valve in its activated state.

Notably, and as seen in the lower graph of FIG. 2, the holding current level L2 is lower than the constant maintenance current level LM at which a valve connected directly to a power supply would settle. This reduces power consumption by the valve, and saves on overall power requirements and energy costs at the irrigation field in which the controller and valve are situated.

Such holding current may be used when operating e.g., AC or DC continuous valves. In cases e.g., where a DC latch valve is being used, the voltage and consequently current may drop to “zero” after dotted line 109.

FIG. 2A combines together portions of sections 106 and 107 to illustrate an example of PWM that may be applied to the valve via the irrigation controller.

Operating an AC type valve by a controller using electrical circuit 10 relies on alternatingly supplying two different voltages to the valve at a predetermined frequency. This may be achieved by controlling the driver 14 via microcontroller 18 to output appropriate voltages at two driver ports 142, 141 in an alternating manner according to a frequency (e.g., 50 Hz, 60 Hz, etc.) that is suited to the AC valve being used.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

What is claimed is:

1. An irrigation controller comprising:
an electrical circuit configured to receive incoming power of either AC or DC voltage and supply power to valves of either AC or DC type, the electrical circuit comprising:
a power supply module configured to convert the incoming power to a first DC voltage that is supplied to the remainder of the electrical circuit,
a driver comprising a plurality of outgoing ports, each outgoing port configured to output a voltage level;
a microcontroller arranged to control activation of an irrigation valve via the driver; and
sensing channels configured to sense electrical current at the outlet ports of the driver and provide sensed data to the microcontroller.

2. The irrigation controller of claim 1, wherein the DC voltage is subject to a low-dropout regulator (LDO) before reaching the microcontroller.

3. The irrigation controller of claim 1, further comprising a booster for boosting the first DC voltage output by the power supply module to a higher second DC voltage, the higher second DC voltage being supplied to the driver.

4. The irrigation controller of claim 1 coupled to a DC type irrigation valve, the DC type irrigation valve being configured to receive a DC voltage from only one of said plurality of outgoing ports of the driver, under the control of the microcontroller.

5. The irrigation controller of claim 1 coupled to an AC type irrigation valve, the AC type irrigation valve being configured to receive voltage from exactly two of said plurality of outgoing ports of the driver under the control of the microcontroller, the microcontroller configured to cause the driver to alternatingly supply voltage from each of said two ports according to an AC frequency of the irrigation valve.

6. The irrigation controller of claim 1 coupled to an irrigation valve, wherein the microcontroller and driver are configured to control activation of the irrigation valve according to a load profile of the irrigation valve.

7. The irrigation controller of claim 6, wherein the microcontroller is configured to detect proper operation of the irrigation valve by (a) sensing inrush electrical current supplied to the irrigation valve by the driver, and (b) comparing the sensed inrush electrical current to the load profile of the irrigation valve.

8. The irrigation controller of claim 6, wherein the microcontroller is configured to set a boundary for inrush current that is supplied to the irrigation valve.

9. The irrigation controller of claim 8, wherein the boundary for inrush current is set according to the expected inrush current to be consumed by the irrigation valve according to its load profile.

10. The irrigation controller of claim 9, wherein the boundary for inrush current is set according to the highest expected inrush current to be consumed by the irrigation valve according to its load profile.

11. The irrigation controller according to claim 1 coupled to an irrigation valve, wherein the microcontroller is configured to detect a transition of the irrigation valve to an open state based on information received via the sensing channels.

12. The irrigation controller of claim 11, wherein a transition to the open state is detected by the microcontroller, if a sensed change in the consumed inrush current corresponds to an expected change according to a load profile of the irrigation valve, the expected change being representative of a transition to the open state.

13. The irrigation controller of claim 11, wherein upon detection of a transition to the open state, the microcontroller is configured to control the driver to initiate pulse width modulation (PWM) to output voltage and supply a resulting current to the irrigation valve.

14. The irrigation controller of claim 13, wherein the PWM provides a holding current to maintain the irrigation valve in the open state.

15. The irrigation controller of claim 13, wherein the irrigation valve is a continuous valve which requires a continuous supply of current to maintain the open state.

16. The irrigation controller of claim 11, wherein upon detection of a transition to the open state, the microcontroller is configured to deactivate voltage supply to the irrigation valve.

17. The irrigation controller of claim 16, wherein the irrigation valve is a DC latch valve.
